(19) United States
(12) Patent Application Publication
(10) Pub. No.: US 2006/0071922 A1
(43) Pub. Date: Apr. 6, 2006

(54) Device and method for up/down converting data output

(76) Inventor: Yu-Pin Chou, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/242,008

(22) Filed: Oct. 4, 2005

(30) Foreign Application Priority Data
Oct. 5, 2004 (TW) 93130136

(51) Int. Cl. G09G 5/00

(52) U.S. Cl. 345/204

(57) ABSTRACT

A method for up/down converting display data employs steps of generating a first clock signal, generating display data, writing the display data into a buffer using the first clock signal, generating a second clock signal, reading out the display data written into the buffer using the second signal, and transmitting the read-out display data to a display module.

### BACKGROUND OF THE INVENTION

1. Field of the Invention

The present invention relates to signal frequency up/down conversion, and more particularly to a device and method for up/down converting a transmission rate when outputting display data to a display panel.

2. Description of Related Art

A display control chip (such as an LCD monitor control chip) is one of the most important elements in the field of display and is used to produce display data and display clock needed by the display panel for displaying images according to a video data received from a signal source. Accordingly, the display panel may in turn display the display data on the panel in accordance with this display clock by taking it as a sampling clock for receiving the display data.

In general, the sampling clock frequency of the display panel for receiving the display data has an upper limit Fmax; that is to say, if the value of the display clock frequency transmitted from the display control chip exceeds the upper limit Fmax, then the display panel cannot normally display the images as originally designed and expected. Therefore, for a normal operation of the display panel, the sampling frequency used when transmitting the display data to the panel needs to be set to a value smaller than Fmax.

However, because the frequency of the display clock generated by the display control chip usually is designated with a value that conforms to the display control chip's own video data processing needs, a display clock frequency with a value smaller than Fmax is not always resulted. In particular, when the display control chip contains complicated operations requiring a higher clock rate, such as image scaling or color processing, this problem becomes more significant.

### SUMMARY OF THE INVENTION

One object of the present invention is to provide a device and method for up/down converting a data output in a display control chip so as to provide a rate of displaying suitable for being used in a subsequent display panel.

According to an embodiment of the present invention, a method for up/down converting display data is disclosed and includes the following steps. A first clock signal is generated. Display data are generated. The display data are written into a buffer using the first clock signal. A second clock signal is generated. The display data written into the buffer are read out using the second signal, and the read-out display data are transmitted to a display module.

According to an embodiment of the present invention, a display control chip for outputting display data to a display module is also disclosed and includes a core unit for producing display data and a first signal, a clock generation unit for producing a second clock signal, and a queue unit for registering the display data. The first clock signal is used by the queue unit for writing the display data generated by the core unit, and the second clock signal is also used thereby for reading out the written display data and transmitting the same to the display module.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing a display monitor according to an embodiment of the present invention;

FIG. 2 is a flow chart showing the steps of a method for up/down converting a data output in an embodiment according to the present invention; and

FIG. 3 is a timing diagram showing the relationship between the display data input in and output from a queue unit and the corresponding data flow rate.

### DETAILED DESCRIPTION OF PREFERRED EMBODIMENTS

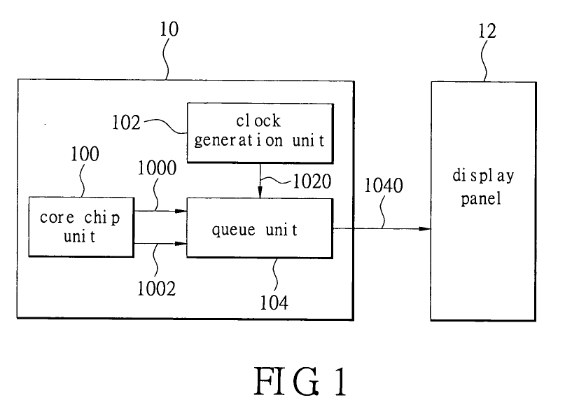

Reference is made to FIG. 1, which illustrates a schematic view of a display monitor in an embodiment according to the present invention. The monitor in FIG. 1 includes a display control chip 10 and a display panel 12. The display control chip 10 generally receives a video data transmitted from a host through a connection interface (not shown) and, after this video data is processed thereby, produces display data for driving the display panel 12 to display the images corresponding to said video data. It should be noted that although in the present embodiment a display panel driven by the display data is taken as an example, the present invention can also be applied to CRT or other displaying technologies.

In this embodiment, the display control chip 10 can be an LCD monitor control chip, but as known by one skilled in the art, it also can be a control chip of other display types. The display control chip 10 includes a core unit 100, a clock generation unit 102 and a queue unit 104. The core unit 100 is a core portion for performing the main function of the control chip 10 and can process the received video data, such as image scaling, color processing, and/or other processing functions of the display control chip, so as to produce display data 1002 needed by the display panel 12. In addition to display data generation, the core unit 100 also can provide a first clock signal 1000 to the subsequent circuitry. Such first clock signal 1000 is usually generated with a clock frequency conforming to the need of the operating frequency of the main function of the core unit 100.

The clock generation unit 102 is used to produce a second clock signal 1020. The frequency of the second clock signal 1020 is used as a sampling frequency for transmitting the display data to the display panel 12, and thus the frequency of the second clock signal 1020 can be controlled to be within an acceptable range for the display panel 12. In other words, the frequency of the second clock signal 1020 should be controlled in a range not to exceed Fmax for ensuring normal operation of the display panel 12. In the present embodiment, there is no limit as to how the clock generation unit 102 generates the second clock signal 1020. A configuration of phase locked loop (PLL) or direct digital synthesis (DDS) can be adopted. The second clock signal 1020 can be generated in reference to the first clock signal, or independent of the first signal. Namely, any known or new clock generation techniques can be implemented herein.

Since the generation of the display data 1002 from the core unit 100 depends on the frequency of the first clock signal 1000 and the transmission of the display data 1002 to the display panel is completed referencing to the second clock signal 1020 for ensuring a normal operation, the present embodiment therefore employs the queue unit 104 for buffering the data accumulation caused by the difference between the frequency of the first and second clock signals. The queue unit 104, on the one hand, may receive the display data 1002 according to the first clock signal 1000 and store the same in a storage space therein and, on the other hand, may in turn output the previously stored data in the storage space to the display panel 12 according to the second clock signal 1020 (labeled as 1040 in FIG. 1). Furthermore, because the queue unit 104 has a sufficient storage space, the display control chip 10 can transmit the display data 1002 generated in a clock domain with higher operating frequency (i.e., the frequency of the first clock signal 1000) to the display panel 12 with a lower rate clocked by the second clock signal 1020, which is acceptable by the display panel 12, through the method described above. In practice, the queue unit 104 can be a buffer register, and in the embodiment, it is a FIFO (fast-in-fast-out) memory.

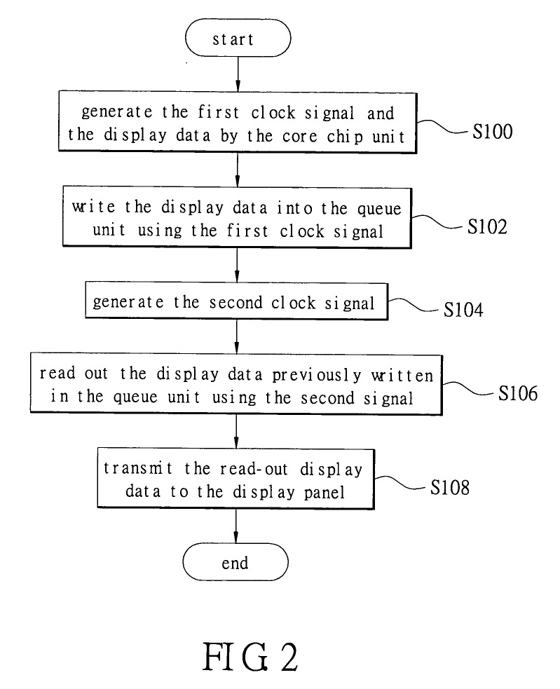

Reference is made to FIG. 2, which illustrates a flow chart of the method for up/down converting a data output according to an embodiment of the present invention, together with FIG. 1. The method includes steps of generating the first clock signal 1000 and the display data 1002 by the core unit 100 (S100), writing the display data 1002 into the queue unit 104 according to the first clock signal 1000 (S102), generating the second clock signal 1020 (S104), reading out the display data previously written in the queue unit 104 according to the second signal 1020 (S106), and transmitting the read-out display data 1040 to the display panel 12 (S108).

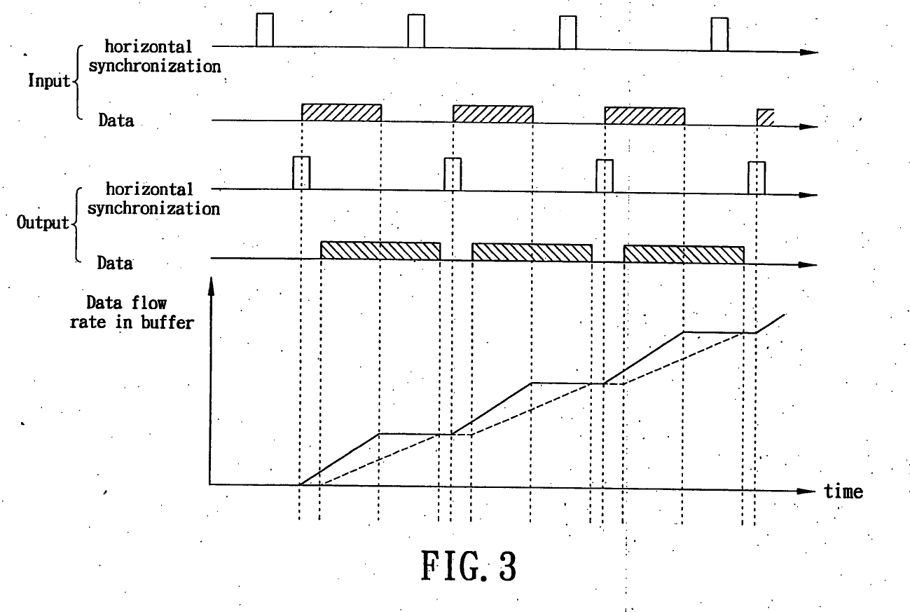

Reference is made to FIG. 3, which illustrates a timing diagram showing a relationship between the display data input in and output from the queue unit 104 and the data flow rate thereof. In FIG. 3, the upper two time axes show the signals, including the horizontal synchronization (HSYNC) signal and the display data, input in the queue unit 104, and the subsequent two time axes show the signals, including the HSYNC signal and the display data, output from the queue unit 104, and the last time axis shows the data flow, including both the in-flow shown as a solid line and the out-flow shown as a dashed line, in the queue unit 104. On the first and the third time axes, the well-known HSYNC signal is used to mark the starting point of each display line in an image frame for the input and output data, respectively. On the second and the fourth time axes, the shadowed areas indicate the flow-in and flow-out of the actual display data, respectively.

As can be obviously seen from FIG. 3, because the display data is input into the queue unit 104 in accordance with a faster clock frequency (the first clock signal 1000), the input time of the display data indicated by the shadowed areas on the second time axis is shorter, and the slope corresponding to the input data flow of the queue unit 104 (i.e., the in-flow rate) is larger. Furthermore, because the display data is output from the queue unit 104 in accordance with a slower clock frequency (the second clock signal 1020), the output time of the display data indicated by the shadowed areas on the fourth time axis is longer and the slope corresponding to the output data flow of the queue unit 104 (i.e., the out-flow rate) is smaller. Under this representation, the maximal difference M between the input data flow (the solid line) and output data flow (the dashed line), as shown in FIG. 3, is namely the minimal buffer depth required by the queue unit 104.

It is to be understood, however, that even though numerous characteristics and advantages of the present invention have been set forth in the foregoing description, together with details of the structure and function of the above embodiment, the disclosure is illustrative only, and changes may be made in detail, especially in matters of shape, size, and arrangement of parts within the spirit of the invention to the full extent indicated by the broad general meaning of the terms in which the appended claims are expressed.

What is claimed is:

1. A method for up/down converting display data, comprising steps of:
generating a first clock signal;
generating display data;
writing said display data into a buffer using said first clock signal;
generating a second clock signal;
reading out said display data being written into said buffer using said second signal; and
transmitting said read-out display data to a display module.

2. The method according to claim 1, wherein said second clock signal and said display data are produced by a core circuit of a display control chip.

3. The method according to claim 1, wherein said second clock signal is produced by a phase locked loop (PLL).

4. The method according to claim 1, wherein said second clock signal is produced through direct digital synthesis (DDS).

5. The method according to claim 1, wherein said second clock signal is produced by referencing said first clock signal.

6. The method according to claim 1, wherein said second clock signal is produced independent of said first clock signal.

7. The method according to claim 1, wherein said second clock signal has a frequency lower than a frequency of the first clock signal.

8. The method according to claim 1, wherein said buffer is a FIFO memory.

9. A display control chip for outputting display data to a display module, comprising:
a core unit for producing said display data and a first clock signal;
a clock generation unit for producing a second clock signal; and
a queue unit for buffering the display data,
wherein said first clock signal is used for writing said display data produced by said core unit to said queue unit, and said second clock signal is used for reading out said written display data from said queue unit and transmitting said read-out display data to said display module.

10. The chip according to claim 9, wherein said second clock signal is produced by a phase locked loop (PLL).

11. The chip according to claim 9, wherein said second clock signal is produced through direct digital synthesis (DDS).

12. The method according to claim 9, wherein said second clock signal is produced by referencing said first clock signal.

13. The method according to claim 9, wherein said second clock signal is produced independent of said first clock signal.

14. The method according to claim 9, wherein said second clock signal has a frequency lower than a frequency of the first clock signal.

15. A display, comprising:
a display module for displaying an image according to display data; and
a display control chip, comprising:
a core unit for producing said display data and a first clock signal;
a clock generation unit for producing a second clock signal; and
a queue unit for buffering the display data;
wherein said first clock signal is used for writing said display data produced by said core unit to said queue unit, and said second clock signal is used for reading out said written display data from said queue unit and transmitting said read-out display data to said display module.

16. The display according to claim 15, wherein said second clock signal is produced by referencing said first clock signal.

17. The display according to claim 15, wherein said second clock signal is produced independent of said first clock signal.

18. The display according to claim 15, wherein said second clock signal has a frequency lower than a frequency of the first clock signal.

19. The display according to claim 15, wherein said display module is a display panel.

20. The display according to claim 19, wherein said display panel is an LCD display panel.
